(19) United States
(12) Patent Application Publication
(10) Pub. No.: US 2005/0045038 A1
(43) Pub. Date: Mar. 3, 2005

(54) Frame structure of an electrostatic precipitator

(76) Inventor: Ping Huang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/653,088

(22) Filed: Sep. 3, 2003

(51) Int. Cl. B03C 3/40

(52) U.S. Cl. 96/83

(57) ABSTRACT

An electrostatic precipitator includes first and second metallic boards for opposite charges to be deposited on, metallic rods, and holding tubes; the boards are positioned one over another with each first board being between respective two second boards; each board has big holes and small holes; the big holes of the first boards are aligned with corresponding small holes of the second boards, and the small holes aligned with corresponding big holes of the second boards; the rods are each inserted through all of the boards to be only in contact with the edges of corresponding small holes; the tubes are positioned around the rods, and inserted through respective big holes such that the boards are spaced; each tube has an annular protrusion on an inner side, and hollows next to the annular protrusions such that each tube can be produced with reduced materials while the rods can be in contact with the protrusions.

### BACKGROUND OF THE INVENTION

1. Field of the Invention

The present invention relates to a frame of an electrostatic precipitator, more particularly one, which is relatively simple in the structure, cheaper to manufacture, and fast and easy to assemble.

2. Brief Description of the Prior Art

Referring to FIGS. 7, and 8, a conventional frame of electrostatic precipitators consists of upper and lower aluminum boards 45, 46, long metallic boards 41 equidistantly spaced apart between the aluminum boards 45, 46, short metallic boards 42, which are each positioned between respective two long metallic boards 41 and equidistantly spaced apart, and metallic rods 43, 44 joined to the aluminum boards 45, 46 at two ends, and inserted through the metallic boards 41, 42 for supporting the metallic boards 41, 42 in position.

The long metallic boards 41 are provided for positive charges to be deposited on. Each long metallic board 41 is formed with several big through holes 411, and small through holes (not numbered) smaller than the big ones 411. The short metallic boards 42 are provided for negative charges to be deposited on. Each short metallic board 42 is formed with big through holes 421, and small through holes (not numbered) smaller than the big ones 421. The short boards 42 are positioned such that the big through holes 421 thereof are aligned with corresponding small through holes of the long boards 41, and the small through holes thereof are aligned with corresponding big through holes 411 of the long boards 41.

The metallic rods 43 are inserted through respective ones of the small holes of the long boards 41 so that they are also inserted through the corresponding big holes 421 of the short boards 42; thus, the metallic rods 43 are apart from the edges of the big holes 421 of the short boards 42, and tightly contact the edges of the small holes of the long boards 41, and in turns, electricity can travel through the long boards 41 via the metallic rods 43 when the electrostatic precipitator is powered. The metallic rods 44 are inserted through respective ones of the big holes 411 of the long boards 41 so that they are also inserted through the corresponding small holes of the short boards 42; thus, the metallic rods 44 are apart from the edges of the big holes 411 of the long boards 41, and tightly contact the edges of the small holes of the short boards 42, and in turns, electricity can travel through the short boards 42 via metallic rods 44 when the electrostatic precipitator is powered.

Sleeves 431 are positioned around the metallic rods 43, and inserted through the big holes 421 of the short boards 42 such that they are positioned between adjacent long boards 41, and distance between the long boards 41 is prevented from changing by means of the sleeves 431. Each metallic rod 43 is joined to insulating sleeves 451, 461 at two end portions thereof, which insulating sleeves 451, 461 are inserted in corresponding ones of holes formed on the upper and the lower aluminum boards 45, 46. And, nuts 452, 462 are coupled to upper and lower ends of each metallic rod 43. And, sleeves 441 are positioned around the metallic rods 44, and inserted through the big holes 411 of the long boards 41 such that they are positioned between adjacent short boards 42, and distance between the short boards 42 is prevented from changing by means of the sleeves 441. Each metallic rod 44 is joined to insulating sleeves at two end portions thereof, which insulating sleeves are inserted in corresponding ones of holes formed on the upper and the lower aluminum boards 45, 46. And, nuts are coupled to upper and lower ends of each metallic rod 44.

Thus, positive charges can be deposited on the long metallic boards 41 via the metallic rods 43, and negative charges on the short ones 42 via the metallic rods 44 when the electrostatic precipitator is powered. When dust in the air is made to have positive charges thereon by means of high voltage electricity, and passed through the electrostatic precipitator, the dust will be attracted to the short metallic boards 42, and in turns, air is cleaned.

However, the insulating sleeves 451, 461, which are used to space out the metallic boards 41, 42, have to be in contact with the metallic rods 43, 44, and have enough thickness otherwise the metallic rods 43, 44 tend to be shaky. Consequently, the insulating sleeves take much material to manufactured, and the cost and the weight of the electrostatic precipitator are increased. Therefore, there is room for improvement in the insulating sleeves.

### SUMMARY OF THE INVENTION

It is a main object of the present invention to provide a frame of electrostatic precipitator to overcome the above disadvantages.

The electrostatic precipitator frame includes several first and second metallic boards for opposite charges to be deposited on, metallic rods, and holding tubes made of insulator. The boards are positioned one over another with each of the first boards being between respective two second boards. Each board has big holes and small holes; the big holes of the first boards are aligned with corresponding small holes of the second boards, and the small holes of the first boards are aligned with corresponding big holes of the second boards. The metallic rods are each inserted through corresponding first and second holes of all of the boards to be only in contact with the edges of corresponding small holes. The holding tubes are positioned around the metallic rods, and inserted through respective big holes such that the boards are equidistantly spaced out by means of the holding tubes. Each holding tube has an annular protrusion on a middle portion of an inner side thereof, and hollows next to the annular protrusions such that each of the holding tubes can be produced with a reduced amount of materials due to the hollows while the metallic rods are in contact with corresponding annular protrusions.

### BRIEF DESCRIPTION OF THE DRAWINGS

This invention will be better understood by referring to the accompanying drawings, wherein:

FIG. 1 is an exploded perspective view of the electrostatic precipitator frame according to the present invention,

FIG. 2 is a perspective view of a holding tube of the electrostatic precipitator frame according to the present invention,

FIG. 3 is a vertical section of the holding tube of the electrostatic precipitator frame according to the present invention,

FIG. 4 is a vertical cross-sectional view of the electrostatic precipitator frame according to the present invention,

FIG. 5 is a partial vertical cross-sectional view of the electrostatic precipitator frame according to the present invention,

FIG. 6 is a perspective view of the electrostatic precipitator frame according to the present invention,

FIG. 7 is a side view of the conventional electrostatic precipitator frame as described in the Background, and

FIG. 8 is a partial cross-sectional view of the conventional electrostatic precipitator frame.

### DETAILED DESCRIPTION OF THE PREFERRED EMBODIMENTS

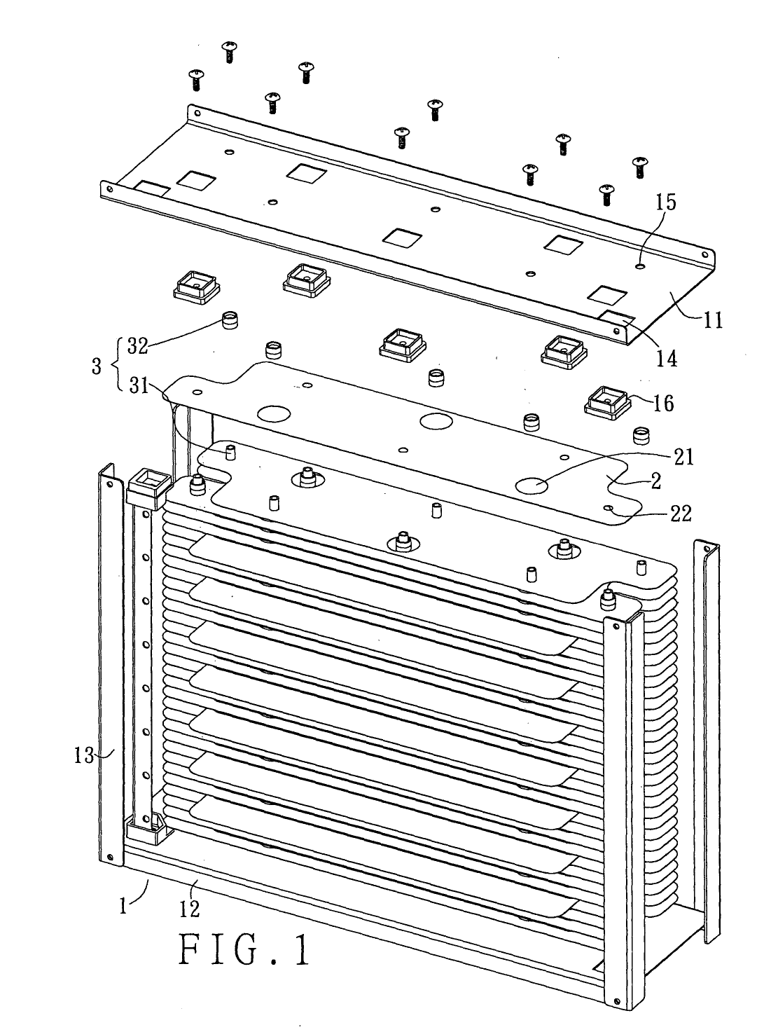

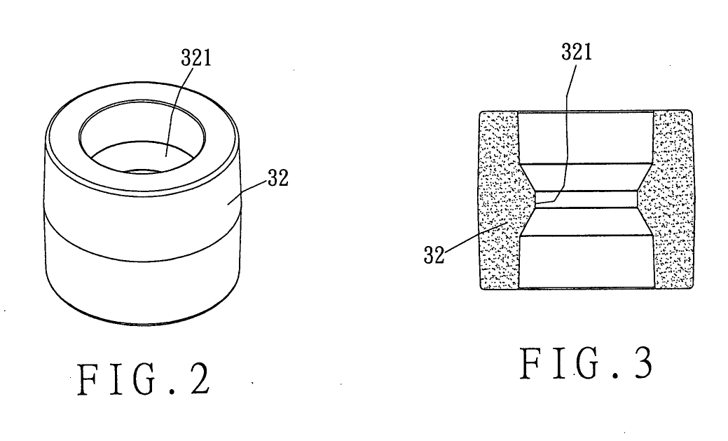

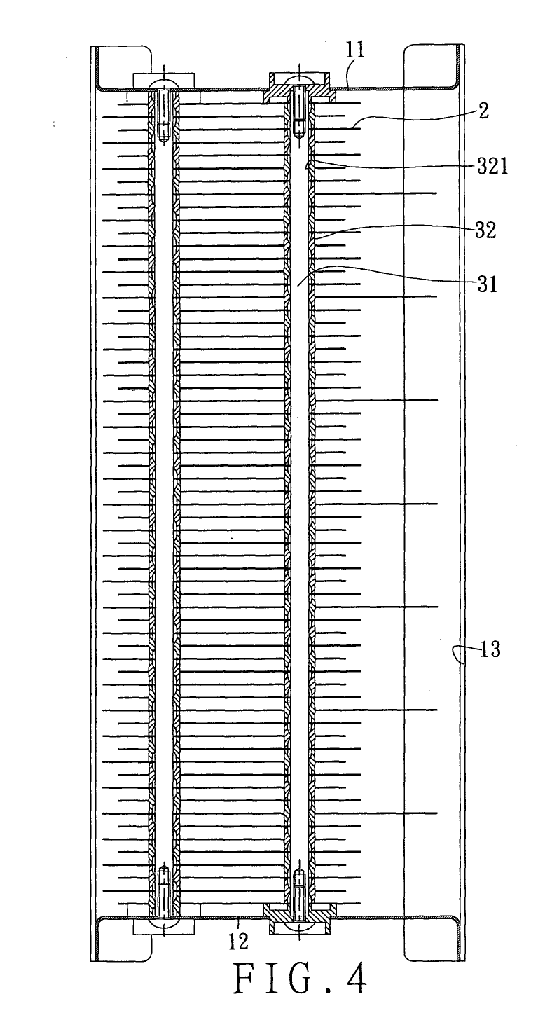

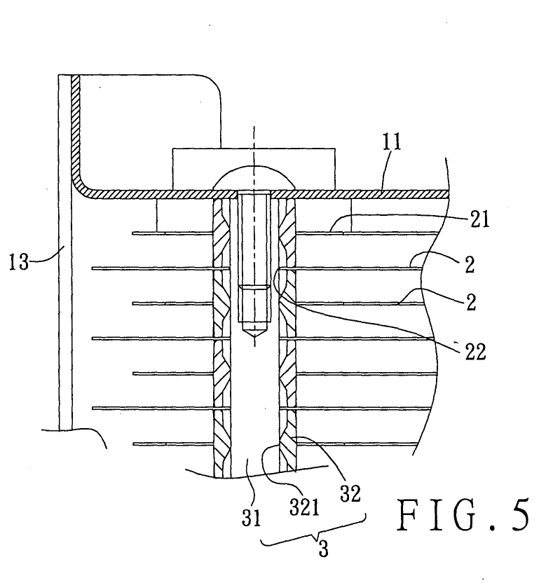

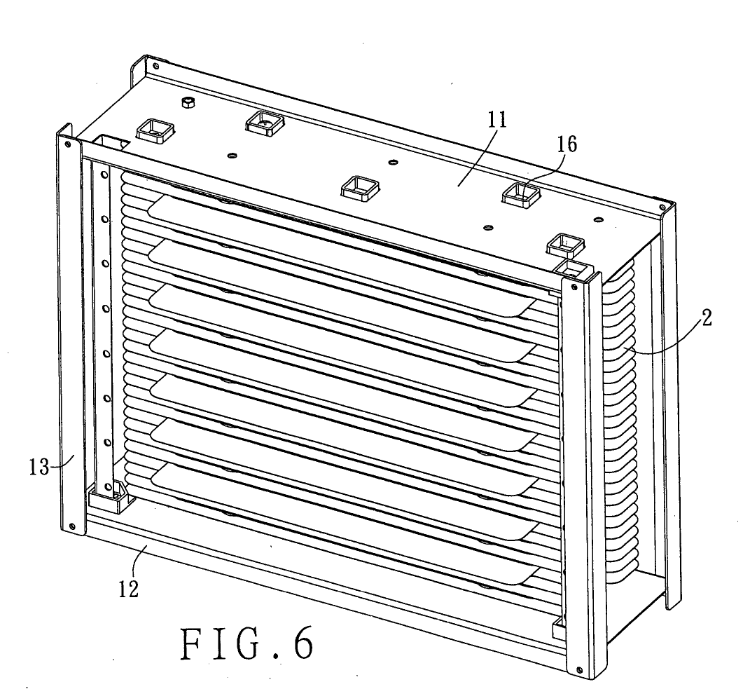

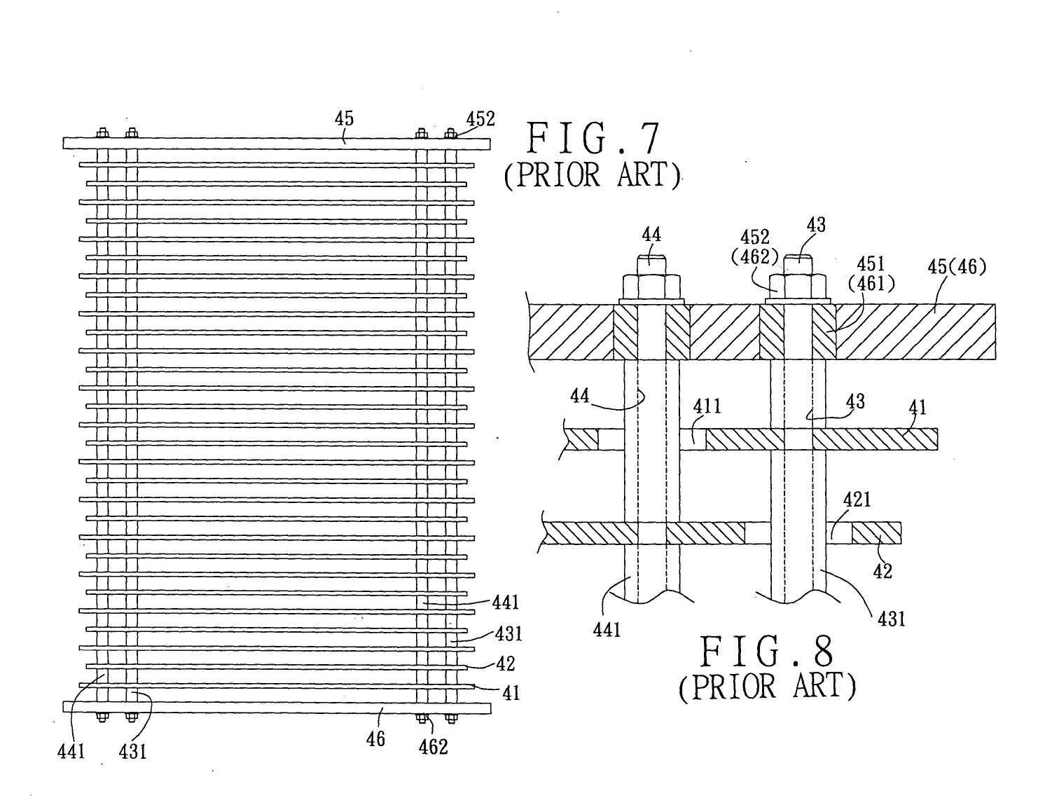

Referring to FIGS. 1 and 2, a preferred embodiment of an electrostatic precipitator frame 1 in the present invention includes an upper board 11, a lower board 12, support rod parts 13, several metallic boards 2, and connecting rods 3, each of which consists of a metallic rod 31, and several holding tubes 32 made of insulator.

The support rod parts 13 are coupled to edges of the upper board 11 at upper ends, and edges of the lower board 12 at lower ends thereof. Each of the boards 11 and 12 has through holes 14, and through holes 15, which are smaller than the through holes 14.

Each of the metallic boards 2 has holes 21, and locating holes 22. The diameter of the holes 21 is larger than the outer diameter of the holding tubes 32 while the diameter of the locating holes 22 is smaller than the outer diameter of the holding tubes 32. In addition, the diameter of the locating holes 22 is the same as that of the metallic rods 31 such that when inserted in one locating hole 22 of one metallic board 2, the metallic rods 31 will be in close contact with this board 2. Each of the holding tubes 32 is formed with an annular protrusion 321 on a middle portion of an inner side thereof; the inner diameter of the annular protrusions 321 is the same as the diameter of the metallic rods 31 so that the annular protrusions 321 can be in close contact with the metallic rods 3, and space is provided between upper and lower portions of the holding tubes 32 and the metallic rods 31 when the holding tubes 32 are positioned around the metallic rods 3.

The metallic boards 2 are grouped into first boards for positive charges to be deposited on, and second boards for negative charges to be deposited on. All of the metallic boards 2 are equidistantly positioned one over another between the upper and the lower boards 11, 12 with the first boards being only adjacent to second boards; in other words, the first boards 2 are positioned between respective two second boards 2. The holes 21 of the first metallic boards 2 are aligned with corresponding locating holes 22 of the second metallic boards 2, and the locating holes 22 of the first metallic boards 2 are aligned with corresponding holes 21 of the second metallic boards 2. And, holes 21 of an uppermost and a lowermost ones of the metallic boards 2 oppose respective small through holes 15 of the boards 11 and 12 while locating holes 22 of the uppermost and the lowermost metallic boards 2 oppose respective large through holes 14 of the boards 11 and 12.

The metallic rods 3 are held in respective ones of the holes 14, 15 of the upper board 11 at upper ends, corresponding holes 21, 22 of the metallic boards 2 at intermediate portions, and corresponding holes 14, 15 of the lower board 12 at lower ends thereof while the holding tubes 32 are positioned around the metallic rods 31, and inserted through respective ones of the holes 21 of the metallic boards 2 such that two ends thereof oppose and abut corresponding locating holes 22 to be in contact with the edges of the corresponding locating holes 22. Thus, the annular protrusions 321 are in close contact with the metallic rods 3, and the first and the second metallic boards 2 are equidistantly spaced apart with each of the first boards 2 being between two of the second boards 2. And, the metallic rods 31 are in close contact with edges of the locating holes 22, and the holding tubes 32 are away from edges of the big holes 21 of the metallic boards 2. Consequently, electricity can travel to the metallic boards 2 via respective metallic rods 31 when the electrostatic precipitator is powered.

Caps 16 are fitted to the big through holes 14 of the boards 11, 12, and coupled to both ends of corresponding connecting rods 3 such that the connecting rods 3 are secured in position by means of the upper and the lower boards 11 and 12, and in turns, the metallic boards 2 are secured in position. And, the first metallic boards and the second metallic boards can have different charges deposited thereon when power is provided to the electrostatic precipitator via the metallic rods 31.

In assembling the present electrostatic precipitator frame, the metallic rods 31 are first coupled to the lower boards 12 at lower ends, and then the holding tubes 32 are positioned around the metallic rods 31, and the metallic boards 2 are positioned around the rods 31 and the holding tubes 32 in sequence.

From the above description, it can be easily understood that the electrostatic precipitator frame of the present invention has an advantage over the prior one as described in the Background because each of the holding tubes 32 is only formed with an annular protrusion 321 on the middle portion of an inner side for close contact with the metallic rods 31, and there are hollows on upper and lower portions of the inner sides of the holding tubes 32. Therefore, it takes a reduced amount of materials to manufacture each of the holding tubes 32 while the holding tubes 32 still can be in contact with the metallic rods 31 in order not to be shaky. Consequently, the cost and the weight of the present electrostatic precipitator are reduced.

1. An improvement on a frame structure of an electrostatic precipitator, comprising
an upper and a lower board;
a plurality of support rod parts coupled to edges of the upper board at upper ends, and edges of the lower board at lower ends thereof;
a plurality of first metallic boards provided for positive charges to be deposited on; each first metallic board having first holes, and second holes thereon;
a plurality of first and second metallic boards for opposite charges to be deposited on, the metallic boards being positioned one over another with the first boards being between respective two second boards; each metallic board having first holes, and second holes thereon;
the first holes of the first metallic boards being aligned with corresponding second holes of the second metallic boards; the second holes of the first metallic boards being aligned with corresponding first holes of the second metallic boards; the first holes having a larger diameter than the second holes;
a plurality of metallic rods firmly joined to the upper and the lower boards at upper and lower ends thereof, and held in corresponding first and second holes of the metallic boards; and
a plurality of holding tubes for spacing the metallic boards with, the holding tubes being positioned around the metallic rods, and inserted through respective first holes such that two ends thereof abut corresponding second holes to be in contact with edges of the corresponding second holes, and such that the metallic boards are equidistantly spaced out;
the first holes having a diameter larger than an outer diameter of the holding tubes; the second holes having a diameter smaller than the outer diameter of the holding tubes; each of the holding tubes being formed with an annular protrusion on a middle portion of an inner side thereof; the annular protrusions having an inner diameter same as both a diameter of the metallic rods and a diameter of the second holes such that the metallic rods are in close contact with respective metallic boards and inner annular protrusions of respective holding tubes; hollows being formed next to the annular protrusions of the holding tubes, allowing each of the holding tubes to be produced with a reduced amount of materials.
